(19) United States
(12) Patent Application Publication
(10) Pub. No.: US 2020/0316864 A1
(43) Pub. Date: Oct. 8, 2020

(54) EXPOSURE APPARATUS AND METHOD FOR PRODUCING EXPOSURE OBJECT

(71) Applicant: SONY CORPORATION, TOKYO (JP)

(72) Inventors: KEI SATOU, KANAGAWA (JP); AKIRA SUZUKI, KANAGAWA (JP); HIDEKAZU KAWANISHI, TOKYO (JP); JUGO MITOMO, KANAGAWA (JP)

(21) Appl. No.: 16/758,290

(22) PCT Filed: Aug. 2, 2018
(86) PCT No.: PCT/JP2018/029041

§ 371 Date: Apr. 22, 2020

(30) Foreign Application Priority Data
Oct. 30, 2017 (JP) 2017-208914

(51) Int. Cl. B29C 64/268

(52) U.S. Cl. CPC B29C 64/268

(57) ABSTRACT

An exposure apparatus includes an optical system unit, a modeling unit, and a separation member. The optical system unit includes an exit region from which light is emitted. The modeling unit includes a modeling region to which photosensitive material is supplied, the photosensitive material being sensitive to the light emitted from the exit region. The separation member is translucent, and is arranged at least between the exit region of the optical system unit and the modeling region. This makes it possible to suppress a deterioration in a performance of an optical system that is caused due to the occurrence of a volatile constituent of photosensitive material.

### TECHNICAL FIELD

The present technology relates to an exposure apparatus including, for example, a stereolithography apparatus, and a method for producing an exposure object, the method being applied to the exposure apparatus.

### BACKGROUND ART

The apparatus for producing a three-dimensional object that is disclosed in Patent Literature 1 includes an exposure system with an illumination source, a vat for containing light-sensitive material that is arranged under the exposure system, and a building plate that is vertically movable in the vat by means of an elevator and on which a three-dimensional object is built (modeled). For example, an illumination source that emits light of any wavelength band from ultraviolet to infrared is used as the illumination source of the exposure system. The exposure system causes light from the illumination source to enter an input optics including a plurality of micro-lenses through light modulators, causes the plurality of micro-lenses to collect the light, and causes the light to be irradiated onto an illumination area on the surface of a light-sensitive material (for example, refer to paragraphs [0018] and [0093] to of the specification, and FIGS. 1 and 2 in Patent Literature 1).

### CITATION LIST

### Patent Literature

Patent Literature 1: Japanese Patent Application Laid-open No. 2012-505775

### DISCLOSURE OF INVENTION

### Technical Problem

When photosensitive material is irradiated with light, this may result in a deterioration in a performance of an optical system, such as a reduction in transmittance of an optical member such as a lens, the reduction being caused by a volatile constituent of, for example, a carbon compound being precipitated on the surface of the optical member due to the photosensitive material being photolyzed.

An object of the present disclosure is to provide an exposure apparatus that can suppress a deterioration in a performance of an optical system that is caused due to the occurrence of a volatile constituent of photosensitive material, and a method for producing an exposure object.

### Solution to Problem

In order to achieve the object described above, an exposure apparatus according to an embodiment includes an optical system unit, a modeling unit, and a separation member.

The optical system unit includes an exit region from which light is emitted.

The modeling unit includes a modeling region to which photosensitive material is supplied, the photosensitive material being sensitive to the light emitted from the exit region.

The separation member is translucent, and is arranged at least between the exit region of the optical system unit and the modeling region.

The separation member prevents a volatile constituent of photosensitive material from adhering to the exit region for light in the optical system unit. Thus, in this modeling apparatus, it is possible to suppress a deterioration in a performance of an optical member including the exit region, and thus to suppress a deterioration in a performance of the optical system unit.

The separation member may have a plate shape.

The separation member may be removable.

This makes it easy to perform tasks regarding maintenance of the separation plate.

The separation member may be a flexible film.

This makes it possible to throw away the film after one use, and there is no need for maintenance of the film, such as cleaning.

The exposure apparatus may further include a film supplying mechanism that is configured to feed and wind the film.

Accordingly, the film supplying mechanism can supply a new film surface as the separation member at a specified timing.

The exposure apparatus may further include a cover that includes an inner region, and covers the optical system unit such that the optical system unit is arranged in the inner region. The separation member is arranged to separate the inner region from the modeling region.

As described above, the separation member may be configured to totally separate the inner region covered with the cover from the modeling region.

The optical system unit includes a movable scanning optical head that includes the exit region.

In the case of a movable scanning optical head, the distance from an exit region to the surface of a liquid of photosensitive material for performing modeling is very short, and thus a volatile constituent of the photosensitive material easily adheres to the exit region. Therefore, the provision of a separation member is highly advantageous in suppressing such adherence.

The separation member may be configured to move integrally with the optical head.

This makes it possible to make the separation member smaller.

The separation member may be a flexible film. The exposure apparatus may further include a film supplying mechanism that is configured to feed and wind the film, and a support member that integrally supports the optical head and the film supplying mechanism.

The optical head may be a line head.

The optical system unit may include a movable scanning optical head that includes a laser scanning unit, a digital micromirror device, or the exit region.

The exposure apparatus may further include at least one of a gas supplying section that supplies gas to the modeling region, or a gas exhausting section that exhausts gas out of the modeling region.

The supply and/or the exhausting of gas makes it possible to remove a volatile constituent of photosensitive material in the modeling region or to reduce the concentration of the volatile constituent. For example, it is possible to decrease the frequency of replacement of the separation member and the frequency of cleaning of the separation member by purging, using gas, the atmosphere in the modeling region including a volatile constituent.

A method for producing an exposure object according to an embodiment is a method for producing an exposure object that is performed by an exposure apparatus, the exposure apparatus including an optical system unit that includes an exit region from which light is emitted, and a modeling unit that includes a modeling region to which photosensitive material is supplied, the photosensitive material being sensitive to the light emitted from the exit region.

The method includes irradiating, by the optical system unit, light onto the photosensitive material through a translucent separation member that is arranged between the exit region and the modeling region.

The photosensitive material is hardened by the irradiation of the light being performed.

### Advantageous Effects of Invention

As described above, the present technology makes it possible to suppress a deterioration in a performance of an optical system that is caused due to the occurrence of a volatile constituent of photosensitive material.

Note that the effect described here is not necessarily limitative and may be any effect described in the present disclosure.

### BRIEF DESCRIPTION OF DRAWINGS

FIG. 1A is a schematic cross-sectional front view of a three-dimensional modeling apparatus that is an exposure apparatus according to a first embodiment. FIG. 1B is a cross-sectional side view of the three-dimensional modeling apparatus.

FIGS. 2A and 2B are a schematic cross-sectional front view of a three-dimensional modeling apparatus according to a second embodiment, and a schematic cross-sectional side view of the three-dimensional modeling apparatus, respectively.

FIG. 3A is a schematic cross-sectional front view of a three-dimensional modeling apparatus according to a third embodiment, and FIG. 3B is a cross-sectional side view of the three-dimensional modeling apparatus.

FIG. 4 is a plan view of the three-dimensional modeling apparatus illustrated in FIG. 3.

FIG. 5A is a schematic cross-sectional front view of a three-dimensional modeling apparatus according to a fourth embodiment, and FIG. 5B is a cross-sectional side view of the three-dimensional modeling apparatus.

FIG. 6 is a schematic cross-sectional front view of a three-dimensional modeling apparatus according to a fifth embodiment.

FIG. 7 is a schematic cross-sectional front view of a three-dimensional modeling apparatus according to a sixth embodiment.

FIG. 8A is a schematic cross-sectional side view of the three-dimensional modeling apparatus illustrated in FIG. 7, and FIG. 8B is a plan view of the three-dimensional modeling apparatus.

FIG. 9 is a cross-sectional view primarily illustrating an optical system unit and a film supplying mechanism in a three-dimensional modeling apparatus according to a seventh embodiment.

FIG. 10 is a cross-sectional view primarily illustrating an optical system unit and a separation plate in a three-dimensional modeling apparatus according to an eighth embodiment.

### MODE(S) FOR CARRYING OUT THE INVENTION

Embodiments according to the present technology will now be described below with reference to the drawings.

### 1. First Embodiment

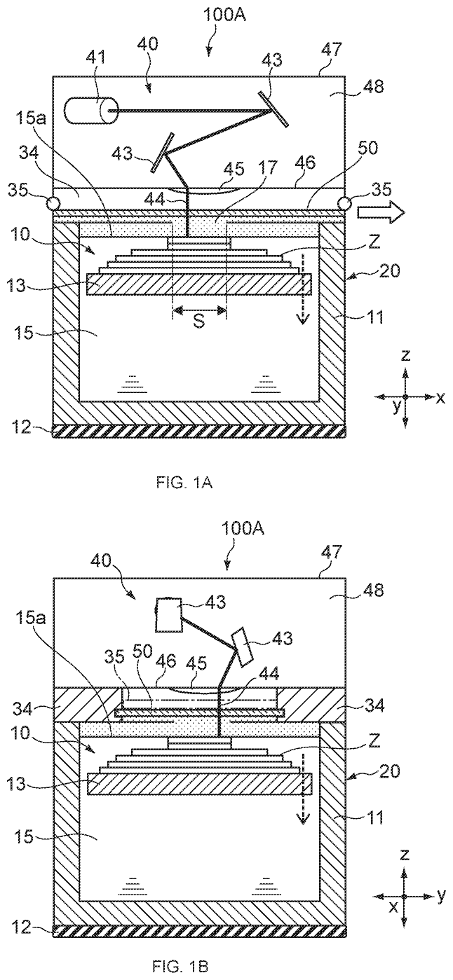

FIG. 1A is a schematic cross-sectional front view of a three-dimensional modeling apparatus (hereinafter referred to as a modeling apparatus) that is an exposure apparatus according to a first embodiment. FIG. 1B is a cross-sectional side view of the modeling apparatus.

A modeling apparatus 100A includes an optical system unit 40 and a modeling unit 20 that is arranged under the optical system unit 40. The optical system unit 40 includes an exit lens 45 that serves as an exit region for light. The modeling unit 20 includes a modeling region 10 to which photosensitive material 15 is supplied, the photosensitive material 15 being sensitive to light emitted from the optical system unit 40.

Further, the modeling apparatus 100A includes a separation plate (plate shape) 50 that is a translucent separation member that is arranged between the exit lens 45 and the modeling region 10.

The modeling unit 20 includes a material tank 11 that is configured to contain the photosensitive material 15, and a modeling stage 13 that is arranged within the material tank 11. Specifically, the modeling region 10 described above refers to a region that is situated within the material tank 11 and above the modeling stage 13. The modeling stage 13 can be moved by a raising-and-lowering mechanism (not illustrated) in an up-and-down direction (a z direction) in the material tank 11. For example, an anti-vibration base 12 is arranged under the material tank 11. The anti-vibration base 12 includes, for example, a mechanism made of rubber or others.

An opening 17 is provided in an upper portion of the material tank 11, in which light (here, laser light) emitted from the exit lens 45 passes through the opening 17.

The optical system unit 40 is covered with a cover 47 to be arranged in an inner region 48 of the cover 47. The cover 47 may be omitted.

The optical system unit 40 includes, for example, a laser scanning unit (LSU). As an LSU, the optical system unit 40 includes a light source 41, scanning mirrors 43, and the exit lens 45 described above. The two scanning mirrors 43 are, for example, galvanometer mirrors that are respectively configured to scan laser light in the horizontal plane, that is, in an x direction and a y direction, the laser light being emitted by the light source 41. For example, an fθ lens is used as the exit lens 45.

For example, light of which a peak wavelength is in the infrared and ultraviolet wavelength regions, is used as the laser light emitted by the light source 41. The laser light is typically light from blue to violet, or ultraviolet light. For example, photocurable resin is used as the photosensitive material.

The photosensitive material is liquid at normal temperature. The photosensitive material on the modeling stage 13 is hardened to form a one-layer modeling object (exposure object) by the scanning mirrors 43 scanning laser light in the horizontal plane. The modeling stage 13 is caused to goes down by the raising-and-lowering mechanism (not illustrated) every time a one-layer modeling object is formed, and this results in forming a three-dimensional modeling object Z. The modeling object is not necessarily limited to being formed of a plurality of layers, but may be a one-layer modeling object such as a film 70.

A support mechanism that supports the separation plate 50 is provided over the material tank 11. The support mechanism includes beams 34 each formed to be long, for example, in the x direction, and clamps 35 provided to the beams 34. For example, two beams 34 are provided to extend in the x direction and are arranged in the y direction. The separation plate 50 is sandwiched to be supported by the beams 34 such that the separation plate 50 is arranged between the exit lens 45 and a surface 15a of a liquid of the photosensitive material 15, and is fixed with the clamps 35.

A known structure can be adopted with respect to the clamp 35, and, for example, the clamp 35 has a structure of holding down the separation plate 50 using an elastic force of, for example, a spring or rubber. Alternatively, instead of, or in addition to this structure, the clamp 35 may have a structure of fixation using, for example, a screw.

As described above, the separation plate 50 has a structure of being removable from the support mechanism. In other words, a user can loosen the fixation of the clamps 35 and remove the separation plate 50 from the support mechanism by sliding and moving the separation plate 50 in the x direction and by picking the separation plate 50 out of the clamps 35. After the removal, maintenance of the separation plate 50, such as cleaning, is performed.

The separation plate 50 is made of material through which light from the light source 41 is transmitted. The material is glass or translucent resin. For example, quartz or sapphire is used as the glass. For example, acrylic or polycarbonate is used as the resin.

A member having a thickness that makes it possible to ensure a relatively high stiffness is used for the separation plate 50. However, a member may be used that has a thickness such that the member is elastically deformable but does not cause bending under its own weight.

Note that the exit lens 45 is supported by a member 46 (refer to FIG. 1B) such as a frame or a plate above the modeling unit 20. The member 46 such as the frame or the plate is provided, for example, on the beams 34 or between the two beams 34.

During modeling processing, a volatile constituent occurs on the surface 15a of a liquid of the photosensitive material 15 in the modeling region 10. In FIGS. 1A and 1B, the volatile constituent is represented by dots. If the separation plate 50 is not provided, there will be a decrease in a performance of the exit lens 45 due to the volatile constituent adhering to the exit lens 45, and this will result in being unable to maintain a desired light transmittance and a desired light collecting accuracy. Consequently, there may be a reduction in modeling accuracy in a modeling object Z.

In particular, when the photosensitive material is an ultraviolet-light curable resin, the volatile constituent of the photosensitive material often includes carbon. If a volatile constituent including carbon adheres to an optical member such as a lens, it will be difficult to remove it, and it will take much effort and it will cost a lot to perform the removal. Further, such a removal task will greatly damage the optical member.

In particular, for the exit lens 45, the fθ lens is expensive, and thus there will be an increase in costs for producing a modeling object if the fθ lens is thrown away after one use.

The separation plate 50 can prevent a volatile constituent of photosensitive material from adhering to the exit lens 45. Thus, in the modeling apparatus 100A, it is possible to suppress a deterioration in a performance of the exit lens 45 including the exit region, and thus to suppress a deterioration in a performance of the optical system unit 40. Consequently, the modeling apparatus 100A can maintain the high modeling accuracy for a long time. Further, it is possible to extend the life of an optical member such as the exit lens 45.

Further, since the separation plate 50 is removable, it is easy to perform tasks regarding maintenance of the separation plate 50, such as cleaning.

In the present embodiment, the separation plate 50 is configured to totally separate the inner region 48 of the cover 47 from the modeling region 10, where the optical system unit 40 is arranged in the inner region 48. This makes it possible to prevent a volatile constituent of photosensitive material from penetrating into the inner region 48 in which the optical system unit 40 is arranged.

### 2. Second Embodiment

Next, a modeling apparatus according to a second embodiment is described. In the following descriptions, regarding, for example, the members and the functions included in the modeling apparatus 100A according to the first embodiment described above, a substantially similar component is denoted by the same reference symbol, and a description thereof is simplified or omitted. Descriptions are made focused on a point of difference.

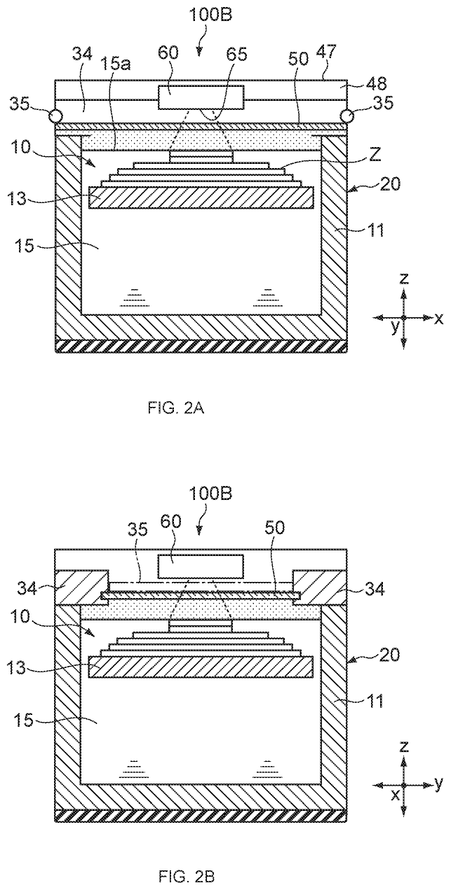

FIGS. 2A and 2B are a schematic cross-sectional front view of a modeling apparatus 100B according to the second embodiment, and a schematic cross-sectional side view of the modeling apparatus 100B, respectively. The modeling apparatus 100B is different from the modeling apparatus 100A in including a digital micromirror device (DMD) 60 that is an optical system unit of the modeling apparatus 100B. The DMD 60 includes a two-dimensional array of a large number of micromirrors off which light from a light source is reflected, and is configured to generate image light by individually controlling the orientations of the micromirrors.

The DMD 60 includes an exit region 65 for light. The exit region 65 may include an optical member such as a lens (not illustrated). The modeling apparatus 100B includes the translucent separation plate 50 arranged between the exit region 65 of the DMD 60 and the modeling region 10 of the modeling unit 20. The separation plate 50 is removable.

The modeling apparatus 100B provides an effect similar to that provided by the modeling apparatus 100A according to the first embodiment described above.

### 3. Third Embodiment

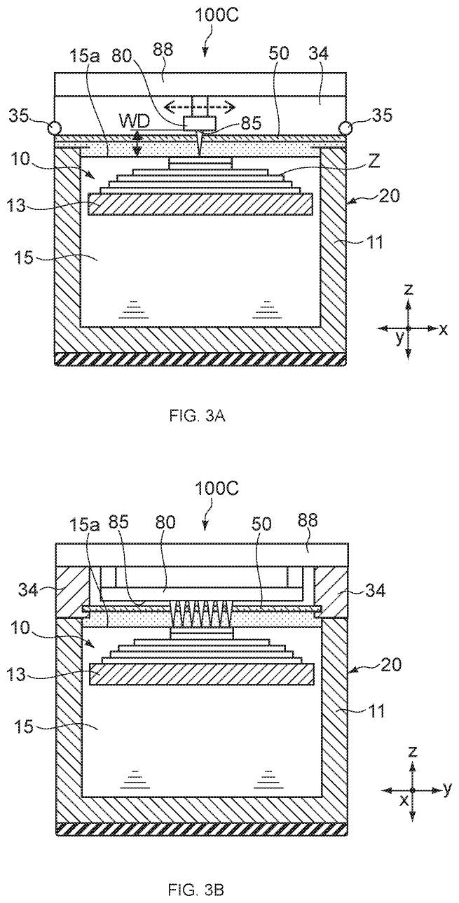

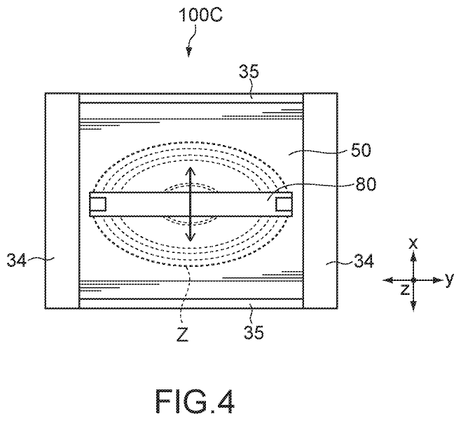

FIG. 3A is a schematic cross-sectional front view of a modeling apparatus according to a third embodiment, and FIG. 3B is a cross-sectional side view of the modeling apparatus. FIG. 4 is a plan view of the modeling apparatus.

An optical system unit of this modeling apparatus 100C includes a movable scanning optical head 80. The optical head 80 is typically a line head. The optical head 80 is configured to emit linear light in a longitudinal direction of the optical head 80 that is the y direction.

The modeling apparatus 100C includes a movement mechanism 88 that moves the optical head 80 in the x direction orthogonal to the longitudinal direction of the optical head 80. In other words, the movement mechanism 88 causes the optical head 80 to perform scanning over the modeling region 10 in the x direction. The movement mechanism 88 is arranged, for example, above the optical head 80. The movement mechanism 88 may be a known mechanism such as a ball screw mechanism or a linear motor mechanism. Note that a cover that covers the optical system unit 40 is not illustrated, but a cover may also be provided. The movement mechanism 88 is not illustrated in FIG. 4.

The optical head 80 that is a line head includes a line light source (not illustrated) that is formed to be long in the longitudinal direction of the head (the y direction). The line light source is formed by, for example, a plurality of point light sources being arranged in a line in the longitudinal direction of the head. A light emitting diode (LED) or a laser diode (LD) is used as the point light source. As described above, the line light source is typically formed of point light sources that are arranged in a single line, but the line light source may be formed of point light sources that are arranged in multiple lines. In the case of being arranged in multiple lines, the point light sources may be provided in, for example, a staggered arrangement.

The optical head 80 includes an exit region for light from the line light source described above. The exit region includes, for example, a condenser lens (not illustrated).

The translucent separation plate 50 is arranged between an exit region 85 of the optical head 80 and the modeling region 10 of the modeling unit 20. The separation plate 50 is removable. For example, the separation plate 50 is provided by being sandwiched by the two beams 34 described above that serve as a support mechanism and being fixed with the clamps 35. Note that the clamps 35 are not illustrated in FIG. 3B.

The modeling apparatus 100C provides an effect similar to those provided by the modeling apparatus 100A according to the first embodiment and the modeling apparatus 100B according to the second embodiment described above. Further, in particular, the working distance (WD) of the movable scanning optical head 80 is very small, compared with those of the LSU and the DMD 60 described above. Here, the WD refers to a distance from the exit region 85 for light to the surface of a liquid of photosensitive material in the modeling region 10. The WDs of the LSU and the DMD 60 are several tens of centimeters, whereas the WD of the optical head 80 is a few millimeters to a few centimeters. Thus, when an optical system unit including the optical head 80 is adopted, a volatile constituent of photosensitive material easily adheres to the optical head 80. However, the provision of the separation plate 50 makes it possible to prevent such adherence.

### 4. Fourth Embodiment

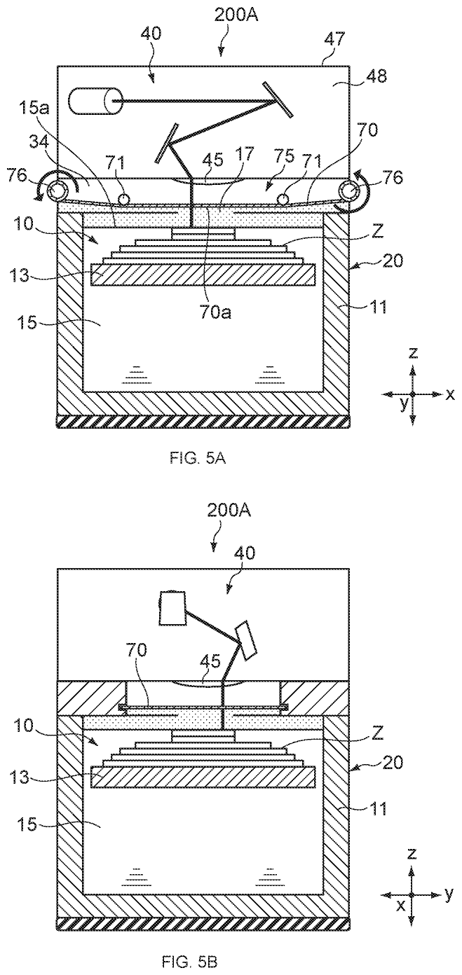

FIG. 5A is a schematic cross-sectional front view of a modeling apparatus according to a fourth embodiment. FIG. 5B is a cross-sectional side view of the modeling apparatus. This modeling apparatus 200A is the modeling apparatus 100A according to the first embodiment described above including a flexible translucent film 70 as a separation member instead of the separation plate 50.

The modeling apparatus 200A further includes a film supplying mechanism 75 that is configured to feed and wind the film 70. The film supplying mechanism 75 includes, for example, a pair of reels 76 and a plurality of (for example, two) tensioners 71. The paired reels 76 are respectively provided, at two ends in the x direction, in a region situated between the optical system unit 40 and the modeling unit 20. One of the reels is a feeding reel, and the other reel is a winding reel.

The tensioners 71 are respectively arranged at positions that cause tension to be applied to the film 70 such that a portion of the film 70 is not bent, the portion being a portion through which light from the optical system unit 40 including an LSU passes. Three or more tensioners 71 may be provided.

For example, epoxy resin, polyvinyl alcohol (PVA), or polyvinyl chloride (PVC) is used as material for the film 70.

For example, the film supplying mechanism 75 supplies the film 70 such that a new surface of the film 70 is exposed (such that a new exposure surface 70a is arranged between the exit region and the modeling region 10) every time a single modeling object Z is formed. The exposure surface 70a is a surface of the film 70 that is situated in a range through which light emitted from the exit lens 45 passes, and is a surface of the film 70 that faces the opening 17 in the present embodiment.

Regarding how frequently the film 70 is supplied, the film 70 is not limited to being supplied every time a single modeling object is formed, but the film 70 may be supplied more frequently or less frequently than every formation of a single modeling object. The modeling apparatus 200A may include a program that can change, depending on the modeling accuracy desired by a user, how frequently the film 70 is supplied.

The film supplying mechanism 75 may be an electrically operated mechanism or a manually operated mechanism. When the film supplying mechanism 75 is an electrically operated mechanism, it is possible to start supplying the film 70 using the film supplying mechanism 75 by a user operating the modeling apparatus 200A or a computer that controls the modeling apparatus 200A. Alternatively, when the film supplying mechanism 75 is an electrically operated mechanism, a sensor (such as an optical sensor) or a computer may monitor the timing of supplying the film 70, and the modeling apparatus 200A may automatically start supplying the film 70, which will be described later.

In the present embodiment, the film 70 can be thrown away after one use since the film 70 is used as a separation member. Thus, there is no need for maintenance of the film 70, such as cleaning.

In the present embodiment, the frequency of supply of a new exposure surface 70a of the film 70 can be made higher, compared to the frequency of maintenance and the frequency of replacement of the separation plate 50 described above. Thus, it is possible to maintain, for a long time, a state in which the separation member is soiled as lightly as possible.

### 5. Fifth Embodiment

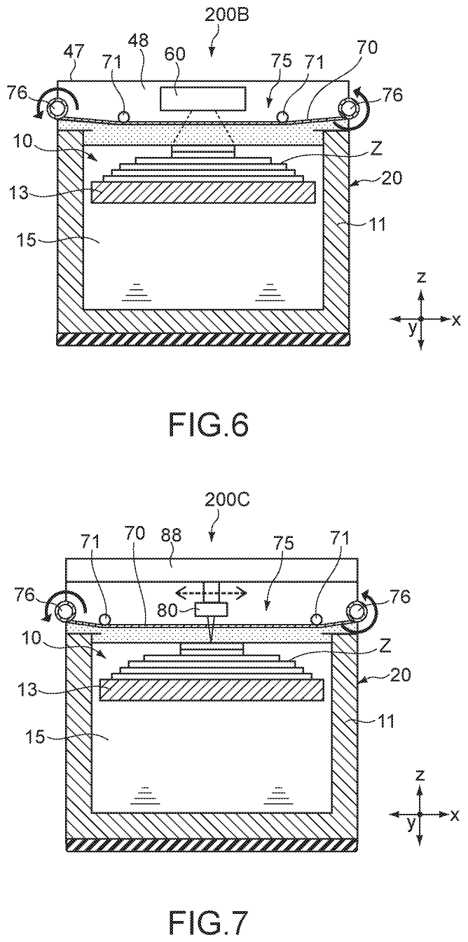

FIG. 6 is a schematic cross-sectional front view of a modeling apparatus according to a fifth embodiment. A modeling apparatus 200B according to the present embodiment is the modeling apparatus 100B according to the second embodiment described above in which the separation plate 50 has been replaced with the film 70, as in the case of the fourth embodiment described above.

This modeling apparatus 200B provides an effect similar to that provided by the modeling apparatus 200A according to the fourth embodiment described above.

### 6. Sixth Embodiment

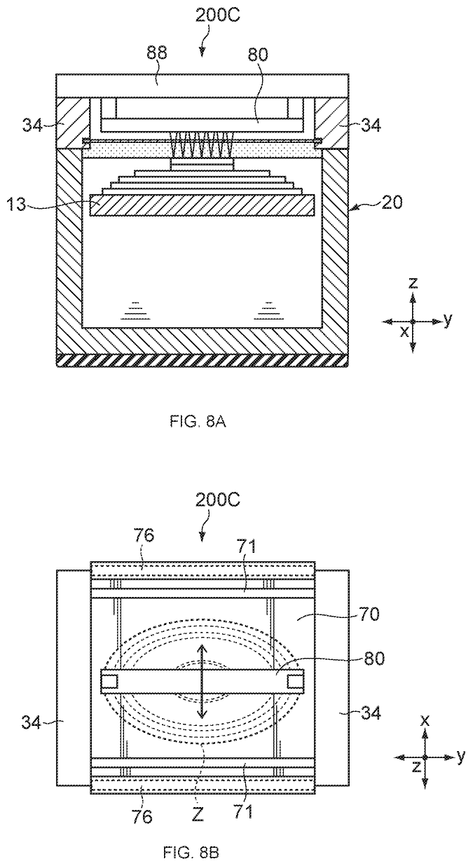

FIG. 7 is a schematic cross-sectional front view of a modeling apparatus according to a sixth embodiment. FIG. 8A is a schematic cross-sectional side view of a modeling apparatus 200C illustrated in FIG. 7, and FIG. 8B is a plan view of the modeling apparatus 200C. The modeling apparatus 200C is the modeling apparatus 100C according to the third embodiment described above in which the separation plate 50 has been replaced with the film 70, as in the case of the fourth and fifth embodiments described above.

This modeling apparatus 200C provides, at the same time, an effect provided by the movable scanning optical head 80 in the modeling apparatus 100C according to the third embodiment and an effect provided by the film 70 in the modeling apparatus 200A according to the fourth embodiment and in the modeling apparatus 200B according to the fifth embodiment.

### 7. Seventh Embodiment

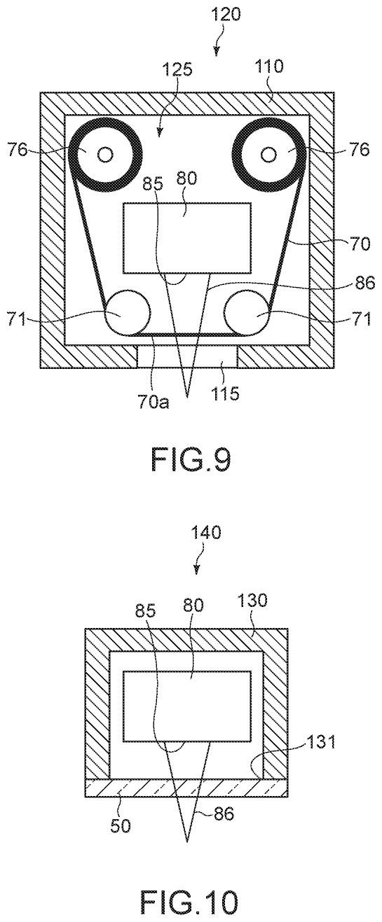

FIG. 9 is a cross-sectional view primarily illustrating an optical system unit and a film supplying mechanism in a modeling apparatus according to a seventh embodiment. The present embodiment is a modification of the sixth embodiment.

An optical system unit 120 includes the movable scanning optical head 80. An optical head similar to those used in the third and sixth embodiments is used as the optical head 80, and, in FIG. 9, the optical head 80 has a shape that is long in a direction vertical to the surface of the sheet of the figure.

This modeling apparatus includes a cartridge 110 that is formed to accommodate the optical head 80. The cartridge 110 serves as a support member that integrally supports the optical head 80 and a film supplying mechanism 125. For example, the optical head 80 is fixed within the cartridge 110. The film supplying mechanism 125 includes the translucent film 70, a pair of reels 76 rotatably provided to feed and wind the film 70, and a plurality of tensioners 71.

An opening 115 through which light 86 from the optical head 80 passes is formed in a portion of the cartridge 110 that faces the exit region 85 for the light 86. The arrangement of the tensioners 71 and the width of the film 70 (the length of the film 70 in the direction vertical to the surface of the sheet of the figure) are designed such that the exposure surface 70a of the film 70 has an area not less than the area of the opening 115, the exposure surface 70a of the film 70 being formed due to tension being applied to the film 70 by the tensioners 71.

The cartridge 110 has an approximate rectangular-parallelepiped shape, but the cartridge 110 may have any shape as long as the cartridge 110 can accommodate the optical head 80. The cartridge 110 is arranged on a modeling unit (not illustrated) such that the exposure surface 70a of the film 70 is arranged between the exit region 85 for the light 86 from the optical head 80 and a modeling region of the modeling unit.

Note that the cartridge 110 may include, for example, a lid (not illustrated) that can be opened and closed, and may be configured such that the optical head 80 is removable from the cartridge 110 with the lid being opened.

The optical head 80 and the film 70 are configured to move in an integrated manner. Specifically, the movement mechanism 88 (not illustrated) for causing the optical head 80 to perform scanning is configured to move the entirety of the cartridge 110. It is sufficient if the movement mechanism 88 has the configuration described in the third and sixth embodiments described above.

The present embodiment provides a structure in which the cartridge 110 integrally supports the optical head 80 and the film supplying mechanism 125, and this makes it possible to make the separation member smaller, that is, to make the area of an exposure surface of the film 70 smaller in this case.

### 8. Eighth Embodiment

FIG. 10 is a cross-sectional view primarily illustrating an optical system unit and a separation plate in a modeling apparatus according to an eighth embodiment. An optical system unit 140 includes the movable scanning optical head 80. In FIG. 10, the optical head 80 has a shape that is long in a direction vertical to the surface of the sheet of the figure.

This modeling apparatus includes a case 130 that accommodates the optical head 80. The case 130 has an approximate rectangular-parallelepiped shape, but the case 130 may have any shape as long as the case 130 can accommodate the optical head 80. The case 130 includes an opening 131, and the separation plate 50 is mounted on the case 130 to cover the opening 131. The optical head 80 is arranged to be fixed within the case 130 such that the exit region 85 for the light 86 and the separation plate 50 face each other.

As in the case of the seventh embodiment described above, the movement mechanism 88 is configured to cause the case 130 to perform scanning such that the case 130 and the optical head 80 move in an integrated manner. It is possible to perform maintenance of the separation plate 50, such as cleaning, by the optical head 80 being removable from the case 130 as in the case of the seventh embodiment, or by the separation plate 50 being removable from the case 130.

As in the case of the seventh embodiment, the present embodiment makes it possible to make the separation plate 50 smaller and to make maintenance of the separation plate 50, such as cleaning, easy.

### 9. Modification

The present technology is not limited to the embodiments described above, and may achieve other various embodiments.

The modeling apparatuses according to the respective embodiments described above may each further include at least a gas supplying section that supplies gas to the modeling region 10, and/or at least a gas exhausting section that exhausts gas (such as gas including a volatile constituent) out of the modeling region 10. The supply and/or the exhausting of gas makes it possible to remove a volatile constituent of photosensitive material in the modeling region 10 or to reduce the concentration of the volatile constituent. For example, air is used as the gas, but inert gas may be used. Gas of, for example, nitrogen or argon is used as the inert gas. For example, in the modeling apparatuses, it is possible to decrease the frequency of replacement of the separation member and the frequency of cleaning of the separation member by purging, using gas supplied from the gas supplying section, the atmosphere in the modeling region 10 including a volatile constituent. Such a gas supplying section and/or such a gas exhausting section may be provided not only in the modeling region 10 but also in a region in which an optical system unit is arranged (such as a region within a cover that covers the optical system unit). Such a gas supplying section and/or such a gas exhausting section may be configured to purge the atmosphere surrounding the optical system unit.

The gas supplying section described above may be configured to form a film gas blow in the modeling region 10. For example, the gas supplying section includes a nozzle that is long in a certain direction and is used to form such a film gas blow. It is sufficient if the nozzle is configured to eject gas to form a gas film (a gas curtain) between an exit region for light and the surface of a liquid of photosensitive material in the x-y horizontal plane in the respective figures of the embodiments described above.

The modeling apparatuses according to the respective embodiments described above may each further include a sensor that monitors a degree of light transmission of a separation member (in particular, the separation plate 50). For example, a reflective or transmissive optical sensor can be used as the sensor. For example, the timing at which a value detected by the optical sensor exceeds a threshold can be set to be a timing of performing maintenance on a separation member or of supplying the separation member (supplying the film 70). The threshold may be set in two or more stages.

Alternatively, the configuration is not limited to using a sensor. For example, a computer can report a timing of performing maintenance on a separation member or of supplying the film 70, using, for example, the number of modeling processing or the time of irradiation of light that is performed by an optical system unit.

For example, in the first and fourth embodiments in which an LSU is used, the separation plate may be shifted by each specific region so that a new region is exposed, as in the case of the film 70. In this case, it is favorable that the area S (refer to FIG. 1A) of the opening 17 of the optical system unit 40 be smaller than the area of the modeling region 10 as viewed from above. Further, in this case, it is necessary that the area of the separation member be set to be larger than the area S of the opening 17 and to be smaller than the area of the modeling region 10 as viewed from above.

The apparatuses according to the respective embodiments described above are each applied to a three-dimensional modeling apparatus, but the apparatuses according to the respective embodiments described above can also be applied to, for example, a maskless exposure apparatus. Alternatively, the present technology is not necessarily limited to being applied to a three-dimensional modeling apparatus for a modeling object that is a hardened object having a plurality of layers, and can also be applied to a modeling apparatus that forms a film modeling object that is a hardened object having a single layer.

The modeling apparatuses according to the respective embodiments described above each have a configuration in which the exit region for light included in the optical system unit is arranged above the material tank 11 (above an upper end of the material tank 11). However, a configuration in which the exit region is arranged below the upper end of the material tank 11, that is, a configuration in which the exit region is arranged inside the material tank 11, also falls within the scope of the present disclosure.

At least two of the features of the embodiments described above can also be combined.

Note that the present technology may also take the following configurations.
(1) An exposure apparatus including:

an optical system unit that includes an exit region from which light is emitted;

a modeling unit that includes a modeling region to which photosensitive material is supplied, the photosensitive material being sensitive to the light emitted from the exit region; and

a translucent separation member that is arranged at least between the exit region of the optical system unit and the modeling region.
(2) The exposure apparatus according to (1), in which

the separation member has a plate shape.
(3) The exposure apparatus according to (2), in which

the separation member is removable.
(4) The exposure apparatus according to (1), in which

the separation member is a flexible film.
(5) The exposure apparatus according to (4), further including a film supplying mechanism that is configured to feed and wind the film.
(6) The exposure apparatus according to any one of (1) to (5), further including a cover that includes an inner region, and covers the optical system unit such that the optical system unit is arranged in the inner region, in which

the separation member is arranged to separate the inner region from the modeling region.
(7) The exposure apparatus according to (1), in which

the optical system unit includes a movable scanning optical head that includes the exit region.
(8) The exposure apparatus according to (7), in which

the separation member is configured to move integrally with the optical head.
(9) The exposure apparatus according to (8), in which

the separation member is a flexible film, and

the exposure apparatus further includes:
a film supplying mechanism that is configured to feed and wind the film; and
a support member that integrally supports the optical head and the film supplying mechanism.
(10) The exposure apparatus according to any one of (7) to (9), in which

the optical head is a line head.
(11) The exposure apparatus according to any one of (1) to (6), in which

the optical system unit includes a movable scanning optical head that includes a laser scanning unit, a digital micromirror device, or the exit region.
(12) The exposure apparatus according to any one of (1) to (11), further including at least one of a gas supplying section that supplies gas to the modeling region, or a gas exhausting section that exhausts gas out of the modeling region.
(13) A method for producing an exposure object that is performed by an exposure apparatus, the exposure apparatus including an optical system unit that includes an exit region from which light is emitted, and a modeling unit that includes a modeling region to which photosensitive material is supplied, the photosensitive material being sensitive to the light emitted from the exit region, the method including:

irradiating, by the optical system unit, light onto the photosensitive material through a translucent separation member that is arranged between the exit region and the modeling region; and

hardening the photosensitive material by the irradiation of the light being performed.

### REFERENCE SIGNS LIST

10 modeling region
15 photosensitive material
20 modeling unit
40, 120, 140 optical system unit
45 exit lens
47 cover
48 inner region
50 separation plate
60 DMD
65, 85 exit region
70 film
75, 125 film supplying mechanism
80 optical head
100A, 100B, 100C, 200A, 200B, 200C modeling apparatus

1. An exposure apparatus comprising:
an optical system unit that includes an exit region from which light is emitted;
a modeling unit that includes a modeling region to which photosensitive material is supplied, the photosensitive material being sensitive to the light emitted from the exit region; and
a translucent separation member that is arranged at least between the exit region of the optical system unit and the modeling region.

2. The exposure apparatus according to claim 1, wherein
the separation member has a plate shape.

3. The exposure apparatus according to claim 2, wherein
the separation member is removable.

4. The exposure apparatus according to claim 1, wherein
the separation member is a flexible film.

5. The exposure apparatus according to claim 4, further comprising a film supplying mechanism that is configured to feed and wind the film.

6. The exposure apparatus according to claim 1, further comprising a cover that includes an inner region, and covers the optical system unit such that the optical system unit is arranged in the inner region, wherein
the separation member is arranged to separate the inner region from the modeling region.

7. The exposure apparatus according to claim 1, wherein
the optical system unit includes a movable scanning optical head that includes the exit region.

8. The exposure apparatus according to claim 7, wherein
the separation member is configured to move integrally with the optical head.

9. The exposure apparatus according to claim 8, wherein
the separation member is a flexible film, and
the exposure apparatus further comprises:
a film supplying mechanism that is configured to feed and wind the film; and
a support member that integrally supports the optical head and the film supplying mechanism.

10. The exposure apparatus according to claim 7, wherein
the optical head is a line head.

11. The exposure apparatus according to claim 1, wherein
the optical system unit includes a movable scanning optical head that includes a laser scanning unit, a digital micromirror device, or the exit region.

12. The exposure apparatus according to claim 1, further comprising at least one of a gas supplying section that supplies gas to the modeling region, or a gas exhausting section that exhausts gas out of the modeling region.

13. A method for producing an exposure object that is performed by an exposure apparatus, the exposure apparatus including an optical system unit that includes an exit region from which light is emitted, and a modeling unit that includes a modeling region to which photosensitive material is supplied, the photosensitive material being sensitive to the light emitted from the exit region, the method comprising:
irradiating, by the optical system unit, light onto the photosensitive material through a translucent separation member that is arranged between the exit region and the modeling region; and
hardening the photosensitive material by the irradiation of the light being performed.
